(19) United States
(12) Patent Application Publication
(10) Pub. No.: US 2009/0009467 A1
(43) Pub. Date: Jan. 8, 2009

(54) SHOOTING SOUND CONTROL METHOD, SHOOTING SOUND CONTROL DEVICE, SHOOTING SOUND CONTROL PROGRAM, AND COMPUTER-READABLE RECORDING MEDIUM

(76) Inventors: Takeshi Isozaki, Tokyo (JP); Kenji Yamamoto, Tokyo (JP)

Correspondence Address: LADAS & PARRY LLP, 224 SOUTH MICHIGAN AVENUE, SUITE 1600, CHICAGO, IL, 60604, US

(21) Appl. No.: 12/279,380

(22) PCT Filed: May 8, 2007
(86) PCT No.: PCT/JP2007/059521

§ 371 Date: Aug. 14, 2008

(30) Foreign Application Priority Data
May 18, 2006 (JP) 2006-139593

(51) Int. Cl. G06F 3/033

(52) U.S. Cl. 345/157; 381/1

(57) ABSTRACT

A method for controlling a shooting sound according to the present invention includes the steps of receiving an operation of a player and generating an operation signal, detecting at which area on a display screen a machine gun is pointing based on the operation signal, and determining one set of sound data at random from sets of sound data on at least two types of shooting sounds in accordance with detected position information.

### TECHNICAL FIELD

The present invention relates to a shooting sound control method, shooting sound control device, shooting sound control program, and computer-readable recording medium, and more particularly to a technology for performing control such that the same shooting sound does not continue in a shooting game and the like where shooting continues without a stop while a trigger of a machine gun is being pulled.

### BACKGROUND ART

Methods for assigning (allotting) the shooting sound of the machine gun and the like in conventional shooting games and the like include:

(1) a method for continuously assigning a sound of a single shot (1 shot sound) in accordance with timing of bullet firing on a screen,
(2) a method for assigning a group of firing sounds collected as a single sound from reloading to running out of bullets when a number of bullets to be fired and a firing time of the machine gun in a single trigger input are determined,
(3) a method for assigning a loop file created to repeat a sound of continuously firing the machine gun in a certain period of time, and the like.

One of the above-mentioned methods is used and the vicinity of a center of the screen is focused on a firing position and the sound is assigned when the center of the screen is moved in a pan control or the same sound is produced when any portion of the screen is shot.

FIG. 1 is a diagram showing a conventional pan control for the shooting sound. A monitor M is divided into a central portion as a “center area”, both sides thereof as a “slightly leftward area” and a “slightly rightward area”, both sides thereof as a “leftward area” and a “rightward area” and both sides thereof as a “left area” and a “right area”. Depending on the area in which a sight (gunsight) S of the machine gun is included, right and left sound volume is increased or reduced so as to obtain stereophonic sound effects.

In addition, relating prior arts are listed below. Objects of these references are to provide stereophonic sound effects such that a character display position on the screen corresponds to a sound source position and to increase linkage between the character and the sound.

Patent Document 1: Japanese Laid-Open Patent Application No. 62-155879

Patent Document 2: Japanese Laid-Open Patent Application No. 4-99580

Patent Document 3: Japanese Laid-Open Patent Application No. 2-10700

Patent Document 4: Japanese Laid-Open Patent Application No. 7-72875

However, shooting sound control in a conventional shooting game and the like is performed as mentioned above, so that the following problems have been pointed out.

(A) The same sound is constantly produced, so that the sound is noticeable compared with other sounds and provides a player with a sense of discomfort.
(B) Although a sense of movement of the sound in the right and left directions is represented by stereo speakers through the pan control, a sense of movement of the sound in the upward and downward directions is not represented.
(C) The shooting sound is produced at the same timing, so that the sound tends to be monotone.

### DISCLOSURE OF INVENTION

It is a general object of the present invention to provide an improved and useful shooting sound control method in which the above-mentioned problems are eliminated.

A more specific object of the present invention is to provide a shooting sound control method that can perform control such that the same shooting sound does not continue so as to create a more natural shooting sound in a shooting game and the like where shooting continues without a stop while a trigger of a machine gun is being pulled.

In order to achieve the above-mentioned objects, according to one aspect of the present invention, as described in claim 1, there is provided a method for controlling a shooting sound comprising the steps of: receiving an operation of a player and generating an operation signal; detecting at which area on a display screen a machine gun is pointing based on the operation signal; and determining one set of sound data at random from sets of sound data on at least two types of shooting sounds in accordance with detected position information.

The method for controlling a shooting sound according to claim 1 may, as described in claim 2, include the step of: gradually enhancing a low-range sound effect of the shooting sound downward in accordance with the detected position information.

The method for controlling a shooting sound according to claim 1 may, as described in claim 3, include the step of: gradually enhancing a high-range sound of the shooting sound upward and gradually enhancing a low-range sound of the shooting sound downward in accordance with the detected position information.

The method for controlling a shooting sound according to claim 1 may, as described in claim 4, include the step of: accelerating or delaying a generation timing of the shooting sound by a predetermined period at a random cycle.

According to another aspect of the present invention, as described in claim 5, there is provided a shooting sound control device comprising: an operation input unit receiving an operation of a player and generating an operation signal; a position detection unit detecting at which area on a display screen a machine gun is pointing based on the operation signal from the operation input unit and outputting detected position information; a sound data storage unit storing a plurality of sets of sound data; an information storage unit storing control information including sound/position correspondence information indicating a correspondence relationship between the area on the display screen and an effect and a shooting sound and sound output timing information; a random number generation unit generating a random number; and a sound control unit controlling the shooting sound based on the position information from the position detection unit and the sound/position correspondence information and the sound output timing information from the information storage unit.

According to another aspect of the present invention, as described in claim 6, there is provided a shooting sound control program for causing a computer to perform a process comprising the steps of: receiving an operation of a player and generating an operation signal; detecting at which area on a display screen a machine gun is pointing based on the operation signal; and determining one set of sound data at random from sets of sound data on at least two types of shooting sounds in accordance with detected position information.

According to another aspect of the present invention, as described in claim 7, there is provided a computer-readable storage medium storing a program for causing a computer to perform a process comprising the steps of: receiving an operation of a player and generating an operation signal; detecting at which area on a display screen a machine gun is pointing based on the operation signal; and determining one set of sound data at random from sets of sound data on at least two types of shooting sounds in accordance with detected position information.

In the shooting sound control method, the shooting sound control device, the shooting sound control program, and the computer-readable storage medium, by performing control such that the same shooting sound does not continue in a shooting game and the like where shooting is set to continue without a stop while a trigger of a machine gun is being pulled, it is possible to create a more natural shooting sound.

### BRIEF DESCRIPTION OF DRAWINGS

FIG. 1 is a diagram showing a conventional pan control of a shooting sound;

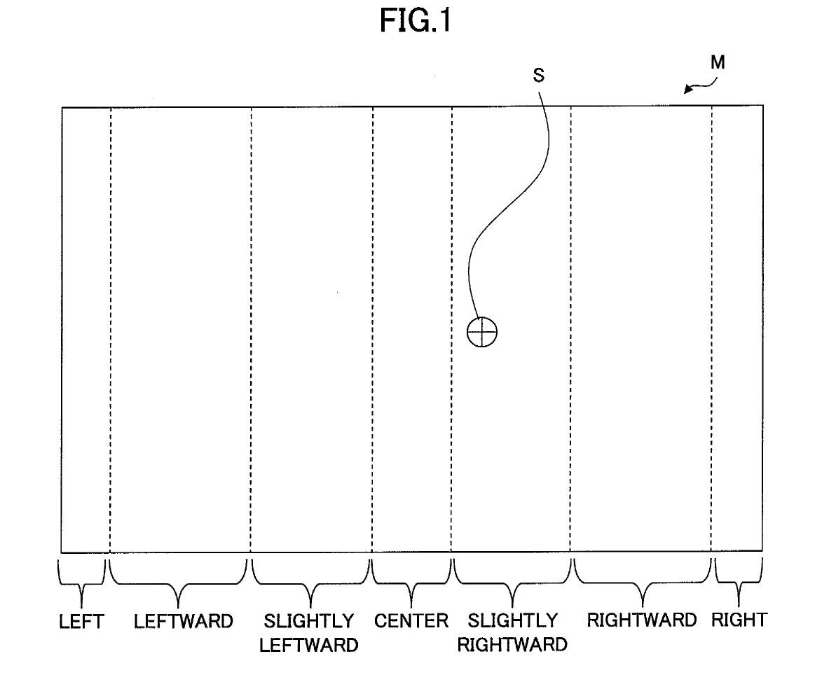

FIG. 2 is a diagram showing an example of a configuration of a shooting sound control device according to an embodiment of the present invention;

FIG. 3 is a diagram showing a correspondence relationship between plural areas divided in upward and downward directions of a monitor and shooting sound control;

FIG. 4 is a flowchart showing an example of processing by a sound control unit; and

FIG. 5 is a diagram showing an example of timing control of a shooting sound.

### DESCRIPTION OF REFERENCE NUMERALS

M: monitor
1: operation input unit
2: position detection unit
3: sound data storage unit
4: information storage unit
5: random number generation unit
6: sound control unit
7: sound generation unit
8: sound output unit

### BEST MODE FOR CARRYING OUT THE INVENTION

The present invention is described in detail based on a preferable embodiment illustrated in the drawings.

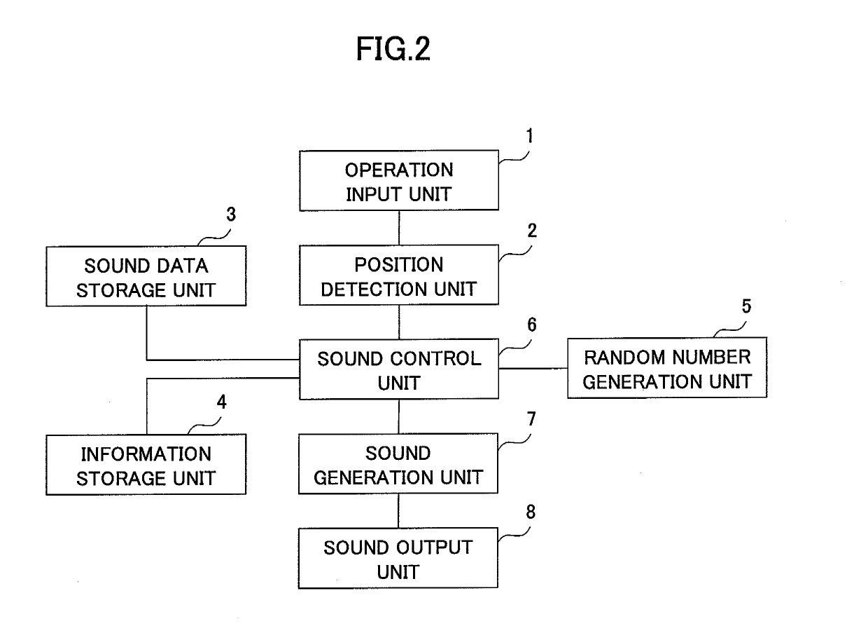

FIG. 2 is a diagram showing an example of a configuration of a shooting sound control device according to an embodiment of the present invention. In general, the shooting sound control device is constructed in an integrated manner with a video game apparatus such as a shooting game and the like. However, only a portion related to sound is shown as the shooting sound control device.

In FIG. 2, the shooting sound control device includes an operation input unit 1 receiving operations of a user (a lever operation, button operation, and the like) and generating an operation signal and a position detection unit 2 detecting at which area on a display screen (monitor) a machine gun is pointing based on the operation signal from the operation input unit 1 and outputting position (area) information. In addition, it is possible to use well-known techniques as disclosed in Japanese Laid-Open Patent Application No. 9-262370, Japanese Laid-Open Patent Application No. 8-257240, and the like as a position detection method. However, the position detection method is not limited to these methods. Any technique may be used as long as a shooting position is detected.

The shooting sound control device further includes a sound data storage unit 3 storing plural sets of sound data (shooting sound data), an information storage unit 4 storing control information such as sound/position correspondence information (information indicating a correspondence relationship between an area on the display screen and effect and shooting sounds), sound output timing information, and a random number generation unit 5 generating random numbers.

Further, the shooting sound control device includes a sound control unit 6 controlling the shooting sound based on the position information from the position detection unit 2, the sound/position correspondence information and the sound output timing information from the information storage unit 4, and the like, a sound generation unit 7 generating a sound (converting from waveform information to sound signals) through control by the sound control unit 6, and a sound output unit (speaker) 8 outputting the sound from the sound signals output from the sound generation unit 7. The sound generation unit 7 is capable of adjusting low-range sound effects (LFE: Low Frequency Effect) when a surround-sound system environment is prepared. Even when such a surround-sound system environment is not prepared, the sound generation unit 7 is capable of adjusting tones (components in each sound range) using an equalizer.

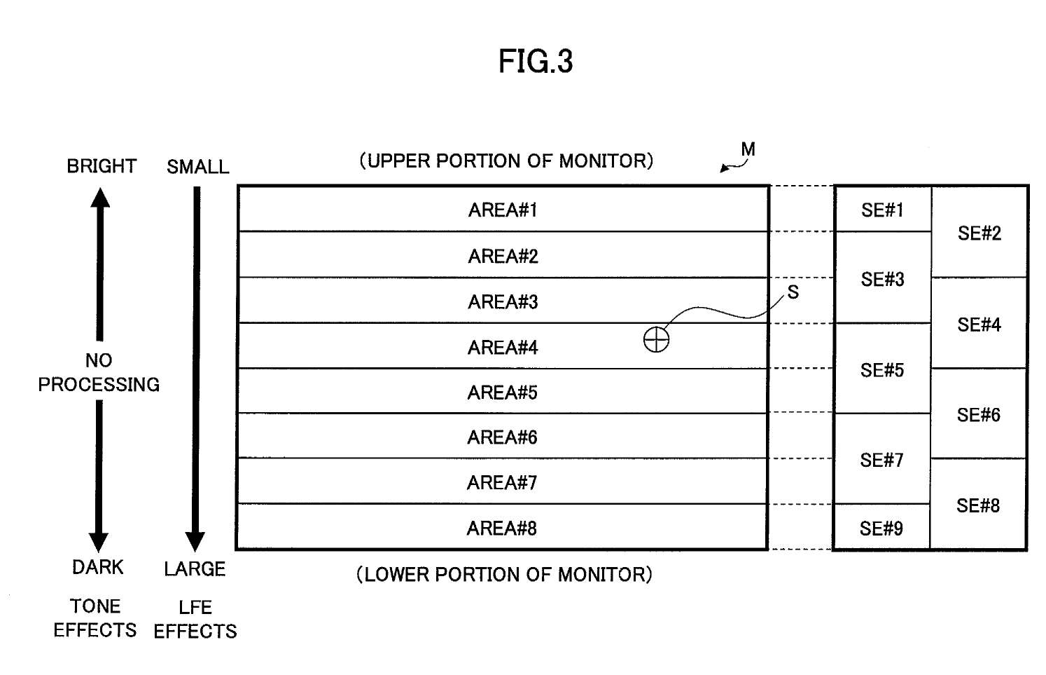

FIG. 3 is a diagram showing a correspondence relationship between plural areas divided in upward and downward directions of a monitor and shooting sound control. The correspondence relationship corresponds to the sound/position correspondence information stored in the information storage unit 4.

In FIG. 3, the monitor M is divided into area #1 to #8 from the upward direction and two sets of sound data SE#1 to #9 are assigned to each area (the tone is changed brightly from SE#5 to SE#1 and changed darkly from SE#5 to SE#9 by contrast). For example, when a sight S of the machine gun is pointing at area #4 as shown in FIG. 3, the sound data SE#5 or SE#4 is selected. In addition, a number of the divided areas on the monitor M is not limited to the example shown in FIG. 3. When the areas are more divided, finer control is possible. However, the control becomes more complicated. Further, a number of sets of sound data assigned to each area may be increased to more than 2.

Further, levels of LFE effects and levels of tone effects are determined depending on the areas #1 to #8 on the monitor M.

In general, in a game where this type of shooting F sound is used, an upper portion of the monitor M is designed to be the sky (in outdoor scenes) or a ceiling (in indoor scenes) and a lower portion is designed to be a front landscape upon looking down. Accordingly, when the surround-sound system environment is prepared, by increasing components of low-range sound effects as shooting is directed downward on the monitor M, it is possible to provide effective presentation such that shooting is directed to the front. Further, even when such a surround-sound system environment is not prepared, by changing effects of the tone of the machine gun brightly toward the upward direction and darkly toward the downward direction, it is possible to provide effective presentation.

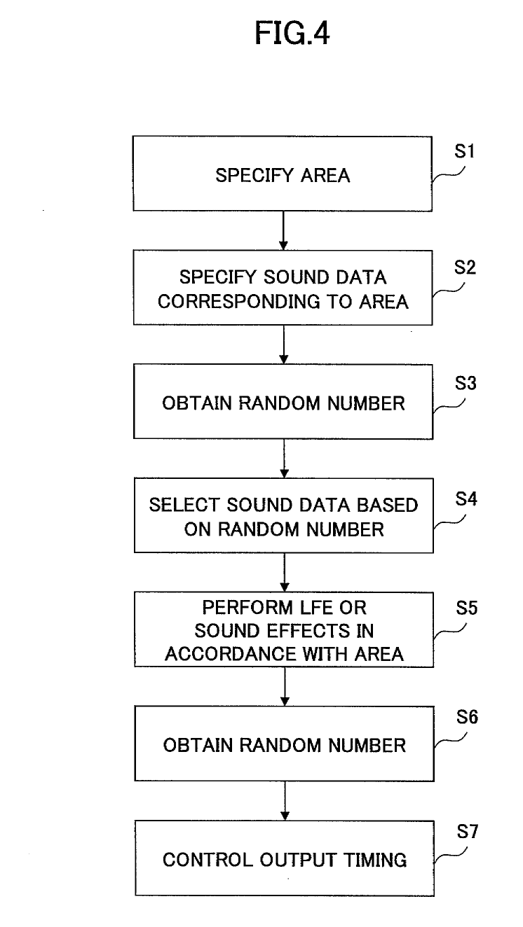

FIG. 4 is a flowchart showing an example of processing by the sound control unit 6.

In FIG. 4, the sound control unit 6 specifies an area at which the machine gun is pointing based on the position information from the position detection unit 2 (step S1) and specifies candidates for sound data to be output for the area by referring to the sound/position correspondence information from the information storage unit 4 (step S2).

Then, the sound control unit 6 obtains a random number from the random number generation unit 5 (step S3) and determines one set of sound data from the candidates for sound data based on the random number (step S4). Specifically, a random number r is generated within a range of 0≦r<1 and is multiplied by a number of candidates (2 in this case), integers (0 and 1 in this case) are extracted, and the extracted integers are assigned to the sound data in ascending order of indexes, thereby determining the sound data.

The determined sound data is read from the sound data storage unit 3 and is handed to the sound generation unit 7 so as to perform sound generation. For example, in FIG. 3, when area #4 at a center of the screen is specified, sound data SE#5 and sound data SE#4 are produced at random. When the machine gun is moved from area #4 to area #3, the tone is changed from sound data SE#5 assigned in area #4 to sound data SE#3 and sound data SE#4 is maintained, so that sound data SE#3 and sound data SE#4 are produced at random. The tone is gradually changed brightly.

Next, the sound control unit 6 refers to the sound/position correspondence information from the information storage unit 4 and performs the LFE or sound effects in accordance with a relevant area (step S5). In other words, when the surround-sound system environment is prepared, the LFE is performed. Even when the surround-sound system environment is not prepared, the tones are adjusted using the equalizer.

Then, the sound control unit 6 obtains a random number from the random number generation unit 5 (step S6) and performs control of generation timing of a shooting sound (step S7).

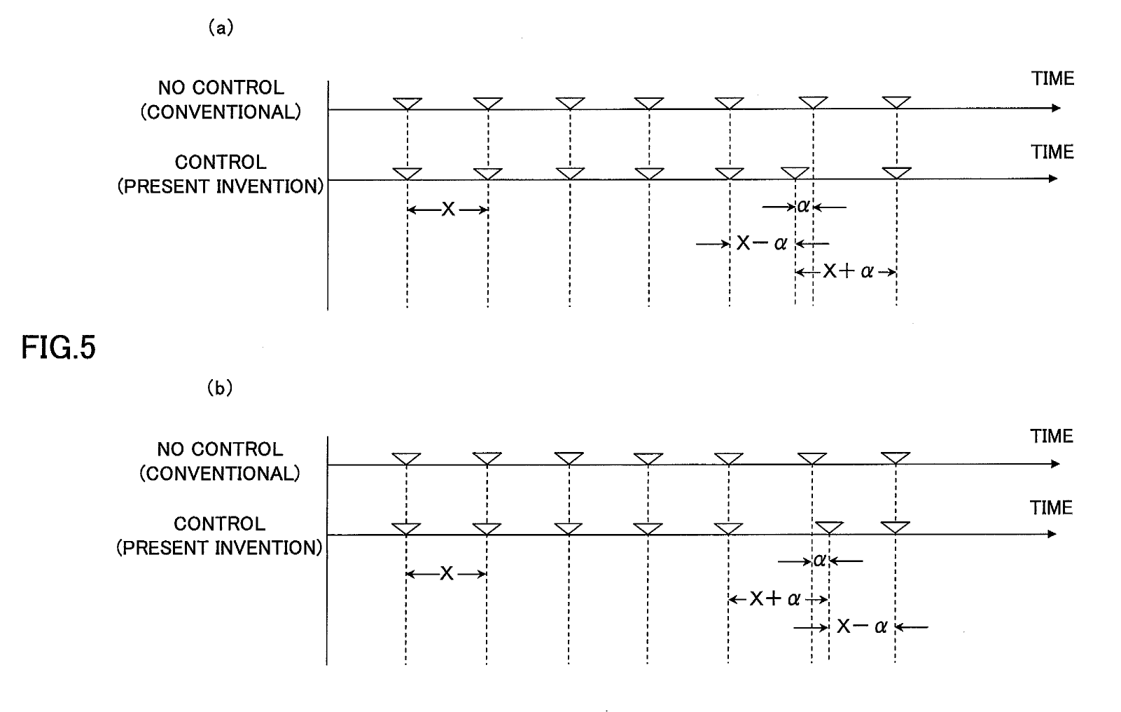

FIG. 5 is a diagram showing an example of timing control of the shooting sound. In a conventional method for producing a single shot sound of a machine gun in which the timing control is not performed, the sound is continuously assigned at each interval of a certain period of time X. However, in the present invention, the sound is assigned at a timing earlier (FIG. 5(a)) or later (FIG. 5(b)) by a time α at irregular intervals determined by the random number. When the timing is accelerated by the time a (FIG. 5(a)), a period immediately before is X−α and a next period is X+α. When the timing is delayed by the time α (FIG. 5(b)), the period immediately before is X+α and the next period is X−α.

In this manner, the machine gun provides a sense of groove and it is possible to produce a more realistic sound of the machine gun.

As mentioned above, in the present invention, the same sound is prevented from being constantly produced and it is possible to avoid providing the player with a sense of discomfort.

In addition, it is possible to represent a sense of movement of the machine gun sound in the upward and downward directions with normal speaker setting.

Further, by shifting the tone of the machine gun and timing of sound production at random, it is possible to reduce flatness and mismatching with other tones.

The present invention is described based on the preferable embodiment of the present invention. In this specification, the present invention is described based on the specifically disclosed example of the present invention. However, it is clear that variations and modifications may be added to the specific example without departing from the broad intention and scope of the present invention defined in claims. In other words, the present invention should not be interpreted as limited by details of the specific example and the attached drawings.

The present application is based on Japanese priority application No. 2006-139593 filed May 18, 2006, the entire contents of which are hereby incorporated herein by reference.

1. A method for controlling a shooting sound comprising the steps of:
receiving an operation of a player and generating an operation signal;
detecting at which area on a display screen a machine gun is pointing based on said operation signal; and
determining one set of sound data at random from sets of sound data on at least two types of shooting sounds in accordance with detected position information.

2. The method for controlling a shooting sound according to claim 1, including the step of:
gradually enhancing a low-range sound effect of said shooting sound downward in accordance with said detected position information.

3. The method for controlling a shooting sound according to claim 1, including the step of:
gradually enhancing a high-range sound of said shooting sound upward and gradually enhancing a low-range sound of said shooting sound downward in accordance with said detected position information.

4. The method for controlling a shooting sound according to claim 1, including the step of:
accelerating or delaying a generation timing of said shooting sound by a predetermined period at a random cycle.

5. A shooting sound control device comprising:
an operation input unit receiving an operation of a player and generating an operation signal;
a position detection unit detecting at which area on a display screen a machine gun is pointing based on said operation signal from said operation input unit and outputting detected position information;
a sound data storage unit storing a plurality of sets of sound data;
an information storage unit storing control information including sound/position correspondence information indicating a correspondence relationship between said area on said display screen and an effect and a shooting sound and sound output timing information;
a random number generation unit generating a random number; and
a sound control unit controlling said shooting sound based on said position information from said position detection unit and said sound/position correspondence information and said sound output timing information from said information storage unit.

6. A shooting sound control program for causing a computer to perform a process comprising the steps of:
receiving an operation of a player and generating an operation signal;
detecting at which area on a display screen a machine gun is pointing based on said operation signal; and
determining one set of sound data at random from sets of sound data on at least two types of shooting sounds in accordance with detected position information.

7. A computer-readable storage medium storing a program for causing a computer to perform a process comprising the steps of:
receiving an operation of a player and generating an operation signal;
detecting at which area on a display screen a machine gun is pointing based on said operation signal; and
determining one set of sound data at random from sets of sound data on at least two types of shooting sounds in accordance with detected position information.
